(19) United States
(12) Patent Application Publication
(10) Pub. No.: US 2025/0159129 A1
(43) Pub. Date: May 15, 2025

(54) IMAGE PROVISION DEVICE AND IMAGE PROVISION METHOD

(71) Applicant: SK hynix Inc., Gyeonggi-do (KR)

(72) Inventor: Yuta SUZUKI, Tokyo (JP)

(21) Appl. No.: 18/939,534

(22) Filed: Nov. 7, 2024

(30) Foreign Application Priority Data
Nov. 9, 2023 (KR) 10-2023-0154080

(51) Int. Cl. H04N 13/383; G06V 10/25; G06V 10/77; G06V 10/82; G06V 20/40; G06V 40/16; H04N 13/111; H04N 13/178

(52) U.S. Cl. CPC H04N 13/383; G06V 10/25; G06V 10/7715; G06V 10/82; G06V 20/46; G06V 40/171; G06V 40/175; H04N 13/111; H04N 13/178

(57) ABSTRACT

An image provision device and an image provision method are disclosed. The image provision device includes a first pre-processor configured to generate a first image by detecting a first face region from each frame of an original video, a second pre-processor configured to generate a second image by detecting a second face region from an original image, and a similar image generator configured to generate similar images respectively corresponding to a viewer's gaze positions based on the first image and the second image.

### CROSS-REFERENCE TO RELATED APPLICATION

This patent application claims the priority and benefits of Korean patent application No. 10-2023-0154080, filed on Nov. 9, 2023, the disclosure of which is incorporated herein by reference in its entirety.

### TECHNICAL FIELD

Embodiments of the present disclosure generally relate to an image provision device and an image provision method capable of providing stereoscopic images (e.g., 3D images).

### BACKGROUND

An image sensing device is a device for capturing optical images by converting light into electrical signals using a photosensitive semiconductor material which reacts to light. With the development of automotive, medical, computer and communication industries, the demand for high-performance image sensing devices has been increasing in various fields such as smart phones, digital cameras, game machines, IoT (Internet of Things), robots, security cameras and medical micro cameras.

In addition, technology has been continuously developed to provide viewers (e.g., users) with three-dimensional (3D) images that can express 3D effect. Recently, research on technology capable of providing viewers (e.g., users) with 3D images without using separate equipment (e.g., 3D glasses) has been continuously conducted. In particular, technology for implementing parallax as a method of displaying different images depending on the viewer's gaze position has been intensively researched and developed. However, in order to implement such technology, it is necessary to prepare multiple images or videos (moving images) according to the viewer's gaze position, which causes considerable inconvenience of use.

### SUMMARY

In accordance with an embodiment of the present disclosure, an image provision device may include a first pre-processor configured to generate a first image by detecting a first face region from each frame of an original video; a second pre-processor configured to generate a second image by detecting a second face region from an original image; and a similar image generator configured to generate similar images respectively corresponding to viewer's gaze positions based on the first image and the second image.

In accordance with another embodiment of the present disclosure, an image provision device may include: a similar image generator configured to generate similar images respectively corresponding to a viewer's gaze positions based on a first image generated using each frame of an original video and a second image generated using an original image; and an image display configured to select a similar image corresponding to a current gaze position of the viewer, among the similar images, and output the selected similar image on a screen.

In accordance with another embodiment of the present disclosure, an image provision method may include: generating a first image using each frame of an original video; generating a second image using an original image; generating similar images respectively corresponding to viewer's gaze positions based on the first image and the second image; and selecting a similar image corresponding to a current gaze position of the viewer, among the generated similar images, and outputting the selected similar image on a screen.

### BRIEF DESCRIPTION OF THE DRAWINGS

The above and other features and beneficial aspects of the embodiments of the present disclosure will become readily apparent with reference to the following detailed description when considered in conjunction with the accompanying drawings.

FIG. 1 is a block diagram illustrating an image provision device according to an embodiment of the present disclosure.

FIG. 2 is a flowchart illustrating an operation of a first pre-processor shown in FIG. 1 according to an embodiment of the present disclosure.

FIG. 3 is a flowchart illustrating an operation of a second pre-processor shown in FIG. 1 according to an embodiment of the present disclosure.

FIG. 4 is a conceptual diagram illustrating an operation of a similar image generator shown in FIG. 1 according to an embodiment of the present disclosure.

FIG. 5 is a conceptual diagram illustrating a method for training a first feature extractor, a second feature extractor, and an image restoration unit shown in FIG. 4 according to an embodiment of the present disclosure.

FIG. 6 is a block diagram illustrating a computing device corresponding to the image provision device of FIG. 1 according to an embodiment of the present disclosure.

### DETAILED DESCRIPTION

The present disclosure provides embodiments of an image provision device capable of providing stereoscopic images (e.g., 3D images) and an image provision method that may be used in configurations to substantially address one or more technical or engineering issues and to mitigate limitations or disadvantages encountered in some other image provision devices. Some embodiments of the present disclosure relate to an image provision device and an image provision method capable of providing three-dimensional (3D) images without preparing multiple images or multiple videos (moving images). In recognition of the issues above, the image provision device and the image provision method according to embodiments of the present disclosure can provide 3D images using only one image and one video (moving image) without preparing multiple images or multiple videos (moving images).

Reference will now be made in detail to the embodiments of the present disclosure, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereinafter, various embodiments will be described with reference to the accompanying drawings. However, it should be understood that the embodiments of the present disclosure are not limited to specific embodiments, but include various modifications, equivalents and/or alternatives of the embodiments. The embodiments of the present disclosure may provide a variety of effects capable of being directly or indirectly recognized.

Various embodiments of the present disclosure relate to an image provision device and an image provision method capable of providing 3D images without preparing multiple images or multiple videos (moving images).

It is to be understood that both the foregoing general description and the following detailed description of the present disclosure are illustrative and descriptive and are intended to provide further description of the embodiments as claimed.

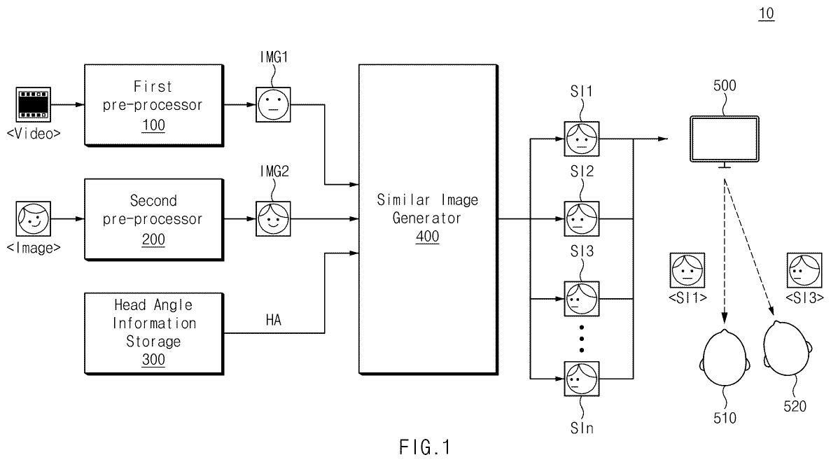

FIG. 1 is a block diagram illustrating an image provision device 10 according to an embodiment of the present disclosure.

Referring to FIG. 1, the image provision device 10 may serve as a device for providing 3D images to a viewer. In particular, the image provision device 10 may provide different images depending on the viewer's gaze position. According to one embodiment, the image provision device 10 may be a head mounted display (HMD) or a 3D display.

The image provision device 10 may include a first pre-processor 100, a second pre-processor 200, a head angle information storage 300, a similar image generator 400, and an image display 500.

The first pre-processor 100 may detect a first image IMG1 by detecting a face region from each frame of an original video (i.e., original moving images). The original video may refer to an image including a face of at least one person. In some embodiments, one person's face is included in the original video, but the scope of the present disclosure is not limited thereto. The technical idea of the present disclosure is substantially applicable even when face images of several persons are included in the original video (however, in this case, the operation of selecting one of the plurality of face images may be added). The original video may include a plurality of frames, and the operation of the first pre-processor 100 may be sequentially performed on the plurality of frames.

In addition, the face region of the first image IMG1 may be a region cropped from each frame of the original video by the first pre-processor 100 to include the person's face. For example, the face region may have a rectangular shape, but the scope of the present disclosure is not limited thereto, and the face region may have any shape (e.g., a circular shape, a hexagonal shape, etc.).

In some embodiments, when a frame of the original video corresponds to the face region, the first pre-processor 100 may omit the operation of cropping the face region from the frame of the original video, and may generate the first image IMG1.

In addition, each frame of the original video may include a color image composed of RGB (red, green, blue) corresponding to color information about a scene, and a depth image including information about the distance to the scene.

The second pre-processor 200 may generate a second image IMG2 by detecting the face region from an original image. The original image may be an image including the face of at least one person. In some embodiments, the original image contains the face of one person for convenience of description, but the scope of the present disclosure is not limited thereto, and the technical idea of the present disclosure is substantially applicable even when face images of several persons are included in the original image (however, in this case, the operation of selecting one of the plurality of face images may be added).

In addition, the face region of the second image IMG2 may be a region cropped from the original video by the first pre-processor 100 to include the person's face. For example, the face region may have a rectangular shape, but the scope of the present disclosure is not limited thereto, and the face region may have any shape (e.g., a circular shape, a hexagonal shape, etc.).

In some embodiments, when the original image corresponds to the face region, the second pre-processor 200 may omit the operation of cropping the face region from the original image, and may generate the second image IMG2.

In addition, the original image may include a color image composed of RGB (red, green, blue) corresponding to color information about a scene, and a depth image including information about the distance to the scene.

In some embodiments, the face region included in each frame of the original video may be defined as a first face region, and the face region included in the original image may be defined as a second face region.

Moreover, a first person corresponding to the first face region may be different from a second person corresponding to the second face region, but the scope of the present disclosure is not limited thereto, and it should be noted that the first person and the second person may be the same person.

The head angle information storage 300 may store head angle information HA including head angles corresponding to each of the viewer's gaze positions. The viewer's gaze position may refer to a relative position of the viewer's head with respect to the screen of the image display 500.

The head angle may include an angle that is rotated about each of a first axis (e.g., X-axis), a second axis (e.g., Y-axis), and a third axis (e.g., Z-axis), which are perpendicular to each other. In some embodiments, the angle obtained when the first axis is used as the rotation axis may be defined as a pitch angle, the angle obtained when the second axis is used as the rotation axis may be defined as a yaw angle, and the angle obtained when the third axis is used as the rotation axis may be defined as a roll angle. That is, the head angle information HA may include a pitch angle, a yaw angle, and a roll angle, which are head angles corresponding to each of the viewer's gaze positions.

The similar image generator 400 may generate similar images SI1 to Sin, where ‘n’ is an integer of 2 or greater) respectively corresponding to the viewer's gaze positions based on the first image IMG1, the second image IMG2, and the head angle information HA. Each of the similar images SI1 to Sin may be an image in which the face of the second image IMG2 has not only a facial expression corresponding to the face of the first image IMG1, but also a head angle of the head angle information HA. Here, the number of similar images SI1 to Sin may be determined in advance based on a range that the viewer's gaze position can have and the number of images to be expressed differently within the range.

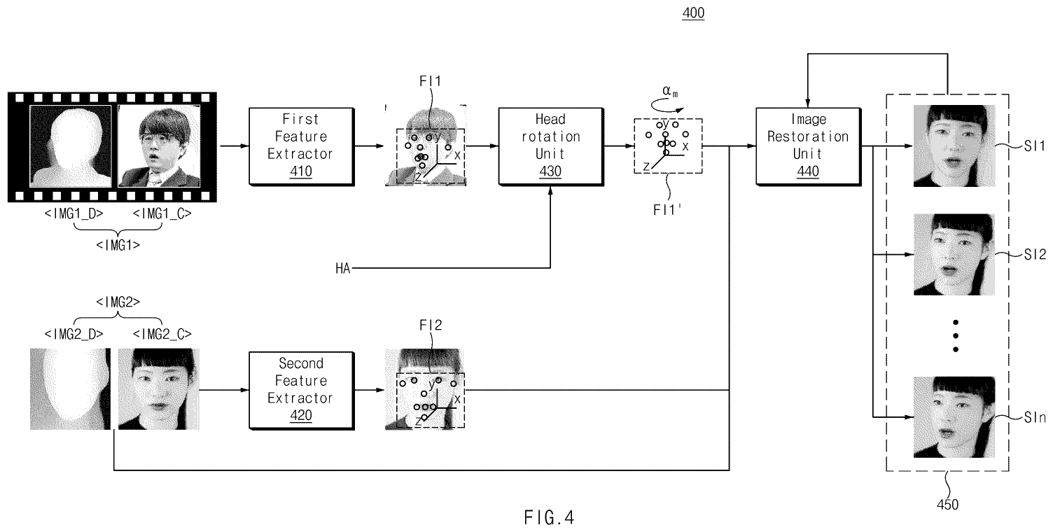

A method for enabling the similar image generator 400 to generate the similar images SI1 to Sin will be described later with reference to FIG. 4.

The image display 500 may select a similar image corresponding to the viewer's current gaze position, from among the similar images SI1 to SIn generated by the similar image generator 400, and may output the selected similar image on the screen. At this time, the image display 500 may not output only the corresponding similar image on the screen, but may output on the screen an image obtained by synthesizing the face region of the original video with the corresponding similar image. Here, such synthesis may mean replacing a face of the person included in the face region of the original video with a face of the person included in the similar image. This synthesis operation may be performed by the image display 500, but may also be performed by a separate image synthesizer (not shown).

The image display 500 may acquire the viewer's current gaze position by recognizing a relative position of the viewer's gaze position with respect to the screen of the image display 500 by using a separate sensor (e.g., a gyro sensor, a pupil sensor, an ultrasonic sensor, an image sensor, etc.) included in the image provision device 10.

In the example of FIG. 1, when the viewer's current gaze position is denoted by 510, the image display 500 may select a first similar image SI1, which is a similar image corresponding to the current gaze position 510, and may output the selected first similar image SI1 on the screen.

Alternatively, when the viewer's current gaze position is denoted by 520, the image display 500 may select a third similar image SI3, which is a similar image corresponding to the current gaze position 520, and output the selected third similar image SI3 on the screen.

As can be seen from the example of FIG. 1, when the viewer's current gaze position is denoted by 510, a face image similar to a front face of the viewer who looks straight ahead may be displayed on the screen. When the viewer's current gaze position is denoted by 520, a face image similar to a left-sided face of the viewer instead of the face image showing the front face of the viewer, may be displayed on the screen.

The image provision device 10 may provide stereoscopic images (e.g., 3D images) corresponding to the viewer's current gaze position by using only one original video and only one image.

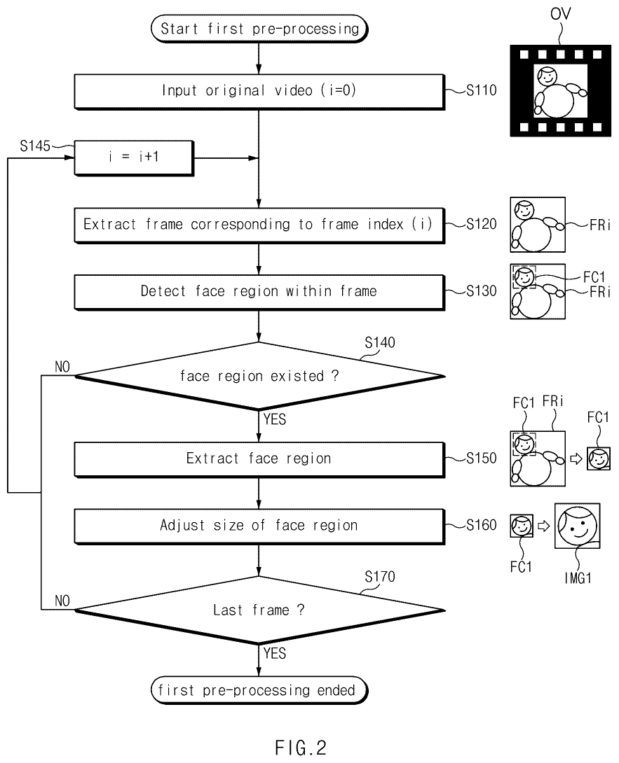

FIG. 2 is a flowchart illustrating an operation of the first pre-processor 100 shown in FIG. 1 according to an embodiment of the present disclosure.

Referring to FIG. 2, the first pre-processor 100 may receive an original video OV (at operation S110). The original video OV may be stored in a memory (not shown) located inside the image provision device 10 and then provided to the first pre-processor 100. The original video OV may include a plurality of frames that proceed sequentially in chronological order, and each of the plurality of frames may be distinguished by a frame index (i). For example, a first frame of the original video OV may have a frame index of 0 (i=0), and a second frame may have a frame index that increases by 1 from 0. In some embodiments, an initial value of the frame index (i) may be set to 0.

The first pre-processor 100 may extract a frame FRi corresponding to the current frame index (i) from the original video OV (at operation S120).

The first pre-processor 100 may detect a face region FC1 within the frame FRi (at operation S130). In some embodiments, a method for detecting the face region FC1 may be implemented as a method of using a face detection algorithm (e.g., Haar-like feature algorithm). In some other embodiments, a method for detecting the face region FC1 may be implemented as a method of manually selecting the face region FC1 through a user input (e.g., mouse dragging) generated by a user of the image provision device 10.

If the face region FC1 is not detected in the frame FRi (i.e., ‘No’ in operation S140), the first pre-processor 100 may increase the frame index (i) by 1 (i=i+1), and may proceed to the next frame to perform the operation S120 again.

If the face region FC1 is detected in the frame FRi (i.e., ‘Yes’ in the operation S140), the first pre-processor 100 may extract the face region FC1 from the frame FRi (at operation S150).

The first pre-processor 100 may adjust the size of the face region FC1 to a predetermined reference size (at operation S160). Here, the reference size may be set to an arbitrary value within a range smaller than the size of the frame FRi. For example, if the size of the frame FRi is 1920×1080, the reference size may be 100×100. In the example of FIG. 2, an example of enlarging the size of the face region FC1 to the reference size is shown for convenience of description, but according to another example, the size of the face region FC1 may also be reduced to the reference size. Here, the enlargement of the face region FC1 may be performed using upscaling techniques (e.g., bilinear, bicubic, nearest neighbor, lanczos, spline, etc.), and the reduction of the face region FC1 may be performed using downscaling techniques (e.g., median, mean, etc.).

The face region adjusted to the reference size may be defined as the first image IMG1.

If the frame index (i) does not correspond to the last frame of the original video OV (i.e., ‘No’ in operation S170), operation S145 may be performed so that the operation S120 may be performed again for the next frame.

If the frame index (i) corresponds to the last frame of the original video OV (i.e., ‘Yes’ in the operation S170), the operation of the first pre-processor 100 may be terminated.

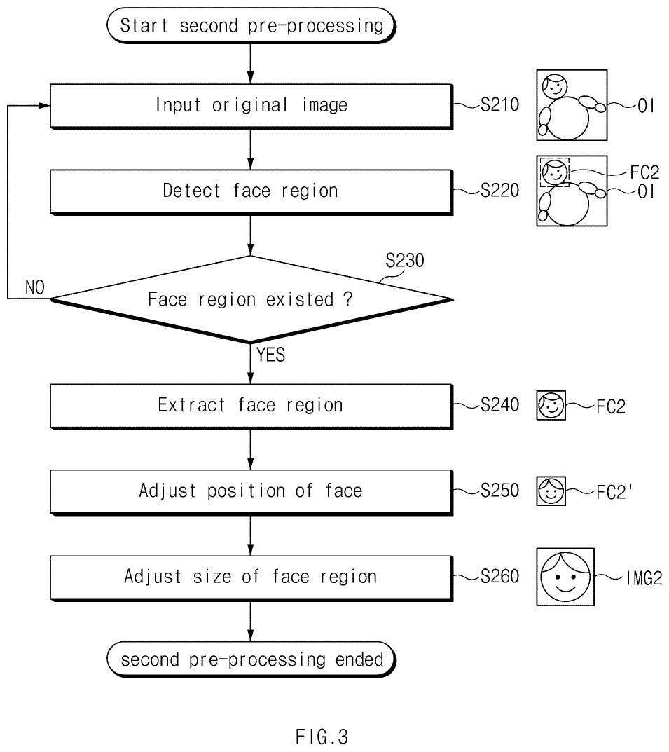

FIG. 3 is a flowchart illustrating an operation of the second pre-processor 200 shown in FIG. 1 according to an embodiment of the present disclosure.

Referring to FIG. 3, the second pre-processor 200 may receive an original image OI (at operation S210). The original image OI may be stored in a memory (not shown) located inside the image provision device 10 and then provided to the second pre-processor 200.

The second pre-processor 200 may detect a face region FC2 within the original image OI (at operation S220). In some embodiments, a method for detecting the face region FC2 may be implemented as a method of using a face detection algorithm (e.g., Haar-like feature algorithm). In some other embodiments, a method for detecting the face region FC1 may be implemented as a method of manually selecting the face region FC2 through a user input (e.g., mouse dragging) generated by a user of the image provision device 10.

If the face region FC2 is not detected in the original image OI (i.e., ‘No’ in operation S230), the second pre-processor 200 may receive another original image OI from a memory (not shown).

If the face region FC2 is detected in the original image OI (i.e., ‘Yes’ in the operation S230), the second pre-processor 200 may extract the face region FC2 from the original image OI (at operation S240).

The second pre-processor 200 may adjust the position of the face included in the face region FC2 to a predetermined reference position (at operation S250). The reference position may refer to a specific position where a straight line interconnecting the centers of two eyes of the face image coincides with a horizontal direction, and another straight line interconnecting the centers of the nose and mouth of the face coincides with a vertical direction. In some embodiments, the second pre-processor 200 may use a contour analysis technique (e.g., wavelet transform) to detect the eyes, nose, and mouth of the face. A face region containing a face with a position adjusted to correspond to the reference position may be defined as an adjusted face region FC2′.

The second pre-processor 200 may adjust the size of the adjusted face region FC2′ to a predetermined reference size (at operation S260). Here, the reference size may be the same size as the reference size described in FIG. 2. In the example of FIG. 3, an example of enlarging the size of the adjusted face region FC2′ to the reference size is shown for convenience of description, but according to another example, the size of the adjusted face region FC2′ may also be reduced to the reference size.

The adjusted face region adjusted to the reference size may be defined as the second image IMG2. When the second image IMG2 is generated, the operation of the second pre-processor 200 may be terminated. By adjusting the face region to the reference position and the reference size, the speed and accuracy of subsequent image processing to be performed by the similar image generator can be further improved.

FIG. 4 is a conceptual diagram illustrating an operation of the similar image generator 400 shown in FIG. 1 according to an embodiment of the present disclosure.

Referring to FIG. 4, the similar image generator 400 may include a first feature extractor 410, a second feature extractor 420, a head rotation unit (i.e., head rotation component) 430, and an image restoration unit 440 (i.e., image restoration component).

The first feature extractor 410 may extract first feature information FI1 from the first image IMG1 including both a first depth image IMG1_D and a first color image IMG1_C. The first depth image IMG1_D may include information about the distance to the scene for each pixel. The first color image IMG1_C may include color information (red, green, blue) about the scene for each pixel.

The first feature information FI1 may be information representing features of the face included in the first image IMG1. In some embodiments, the first feature information FI1 may include landmark information and rotation information.

The landmark information may include 3D coordinates for a facial landmark (e.g., at least one of nose, mouth, eyes, ears, and chin). Here, the landmark may mean a representative point of each eye, nose, mouth, chin, and ear. For example, the representative point may be the center of each of the nose, eyes, ears, mouth, and chin, but the scope of the present disclosure is not limited thereto.

The rotation information may include rotation angles (i.e., a pitch angle, a yaw angle, and a roll angle) obtained when the face rotates about each of a first axis (X-axis), a second axis (Y-axis), and a third axis (Z-axis).

In some embodiments, the first feature extractor 410 may generate first feature information FI1 from the first image IMG1 using the deep learning model (e.g., U-net encoder, self-attention GAN (generation adversarial networks) encoder, etc.) required to analyze the features of the image.

The second feature extractor 420 may extract second feature information FI2 from the second image IMG2 including both a second depth image IMG2_D and a second color image IMG2_C. The second depth image IMG2_D may include information about the distance to the scene for each pixel. The second color image IMG2_C may include color information (red, green, blue) about the scene for each pixel.

The second feature information FI2 may be information representing features of the face included in the second image IMG2. In some embodiments, the second feature information FI2 may include landmark information and rotation information.

The landmark information may include 3D coordinates for landmarks for each of the nose, mouth, eyes, ears, and chin of the face. The rotation information may include rotation angles (i.e., a pitch angle, a yaw angle, and a roll angle) obtained when the face rotates about each of the first axis (X-axis), the second axis (Y-axis), and the third axis (Z-axis).

In some embodiments, the second feature extractor 420 may generate second feature information FI2 from the second image IMG2 using the deep learning model (e.g., U-net encoder, self-attention GAN encoder, etc.) required to analyze the features of the image.

The head rotation unit 430 may generate correction feature information FI1′ by converting the first feature information FI1 in response to the head angle information HA. In some embodiments, when the face is rotated so that a pitch angle, a yaw angle, and a roll angle included in the rotation information of the first feature information FI1 are respectively equal to the pitch angle, the yaw angle, and the roll angle included in the head angle information HA, the head rotation unit 430 may calculate 3D coordinates of each landmark to be changed in response to such rotation.

For example, as illustrated in FIG. 4, when the face must be rotated counterclockwise by a preset angle (am) about the second axis (Y-axis) in a manner that the pitch angle and the roll angle included in the rotation information of the first feature information FI1 become the same as the pitch angle and the roll angle included in the head angle information HA and the yaw angle of the rotation information becomes the same as the yaw angle of the head angle information HA, the head rotation unit 430 may calculate 3D coordinates of each landmark to be changed in response to such rotation by using 3D modeling techniques.

The image restoration unit 440 may generate similar images SI1 to SIn based on the correction feature information FI1′, the second feature information FI2, and the second image IMG2.

Each of the similar images SI1 to SIn may correspond to one head angle information HA, and the number of similar images SI1 to SIn may be equal to the number of head angles included in the head angle information HA. That is, the operation for enabling the image restoration unit 440 to generate a similar image may be repeated N times for each head angle information HA.

The image restoration unit 440 may reflect a facial expression (e.g., a mouth shape as in the example of FIG. 4) and a head angle shown in the correction feature information FI1′ to the second feature information FI2, and may restore the second feature information FI2 to a color image by referring to the second image IMG2, resulting in formation of a similar image.

In some embodiments, the image restoration unit 440 may generate similar images SI1 to SIn based on the correction feature information FI1′, the second feature information FI2, and the second image IMG2 by using the deep learning model (e.g., U-net decoder, self-attention GAN decoder, etc.) required to restore the image from image features.

The image restoration unit 440 may generate a current similar image by referring to previously created similar images, and may thus improve consistency between similar images.

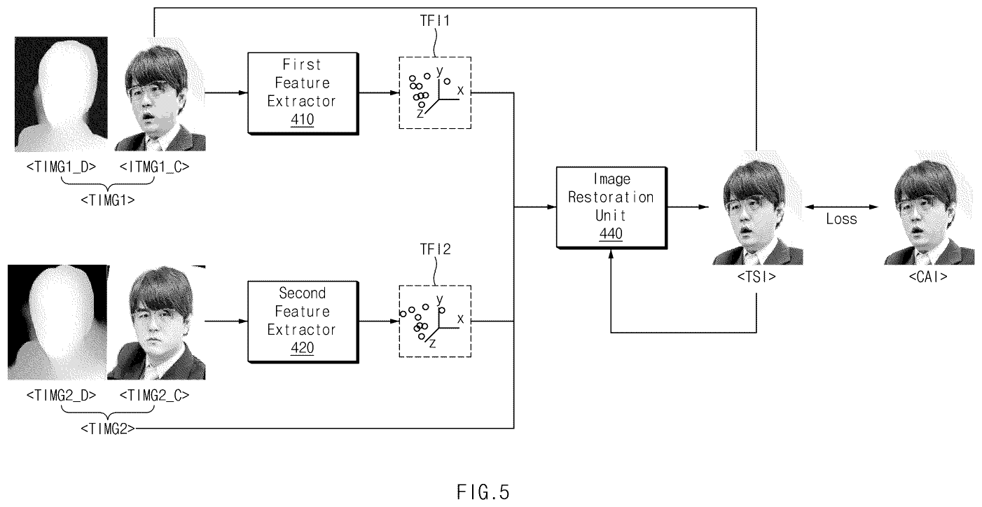

FIG. 5 is a conceptual diagram illustrating a method for training the first feature extractor 410, the second feature extractor 420, and the image restoration unit 440 shown in FIG. 4 according to an embodiment of the present disclosure.

Referring to FIG. 5, when the first feature extractor 410, the second feature extractor 420, and the image restoration unit 440 are implemented as a deep learning model, learning for the deep learning model may be performed using a first learning image TIMG1 and a second learning image TIMG2 extracted from one video. The first learning image TIMG1 may be a cropped image of the face of a specific person included in one frame of the video, and the second learning image TIMG2 may be a cropped image of the face of the specific person included in another frame of the video. Frames respectively corresponding to the first learning image TIMG1 and the second learning image TIMG2 may be randomly selected.

The first feature extractor 410 may extract first learning feature information TFI1 from the first learning image TIMG1 including both a first learning depth image TIMG1_D and a first learning color image TIMG1_C.

The second feature extractor 420 may extract second learning feature information TFI2 from the second learning image TIMG2 including both a second learning depth image TIMG2_D and a second learning color image TIMG2_C.

The image restoration unit 440 may generate a learning similar image TSI based on the first learning feature information TFI1, the second learning feature information TFI2, and the second learning image TIMG2.

The image restoration unit 440 may reflect a facial expression and a head angle shown in the first learning feature information TFI1 to the second learning feature information TFI2, and may restore the second learning feature information TFI2 to a color image by referring to the second learning image TIMG2, resulting in formation of a similar image TSI.

In addition, the image restoration unit 440 may generate a learning similar image TSI by referring to a previously generated learning similar image.

As a weight that constitutes the first feature extractor 410, the second feature extractor 420, and the image restoration unit 440 is changed such that a difference value (denoted by ‘loss’ in FIG. 5) between a correct answer image CAI and the learning similar image TSI can be minimized, learning of the deep learning model may be performed. Such learning may be considered more effective when using many more learning images and many more videos as learning data.

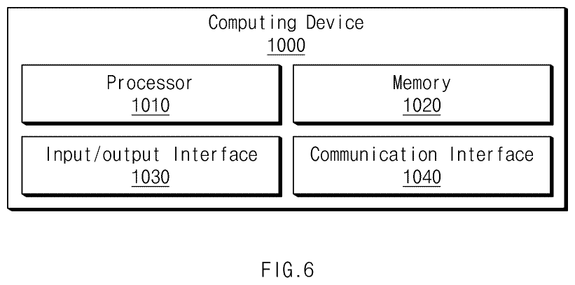

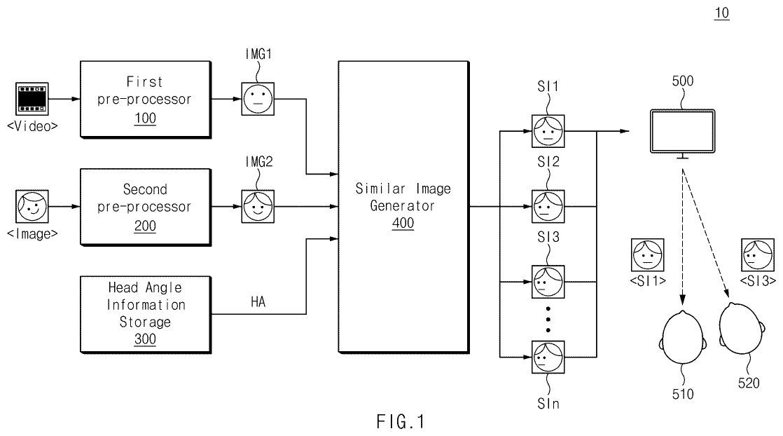

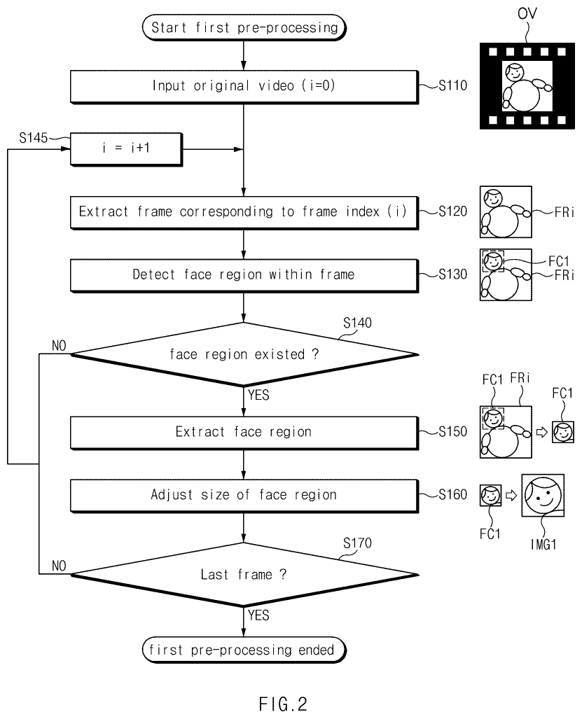

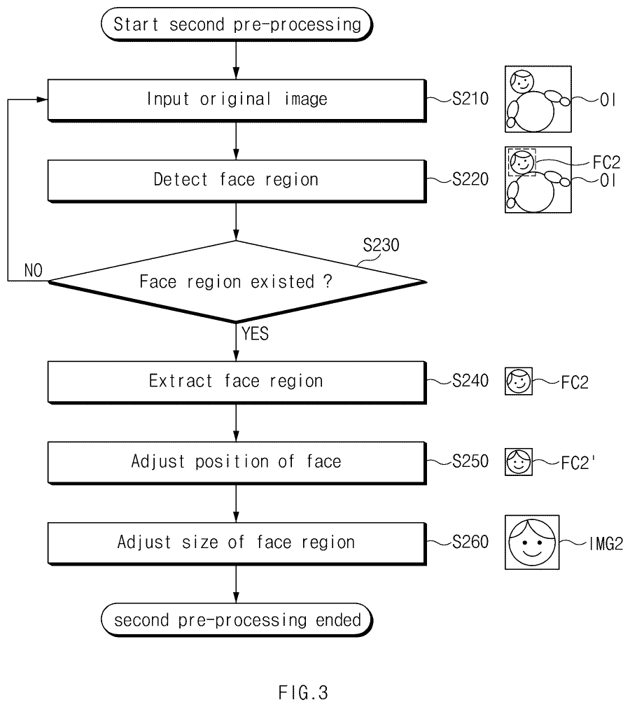

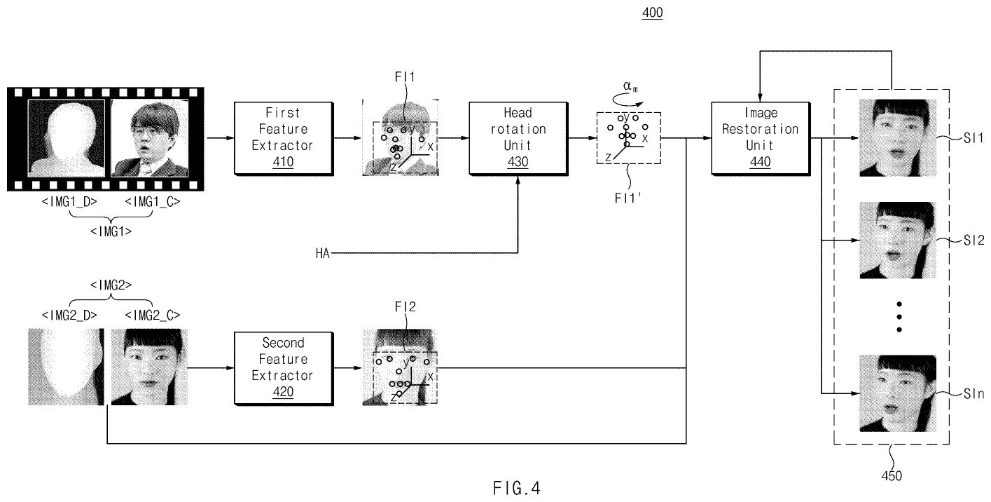

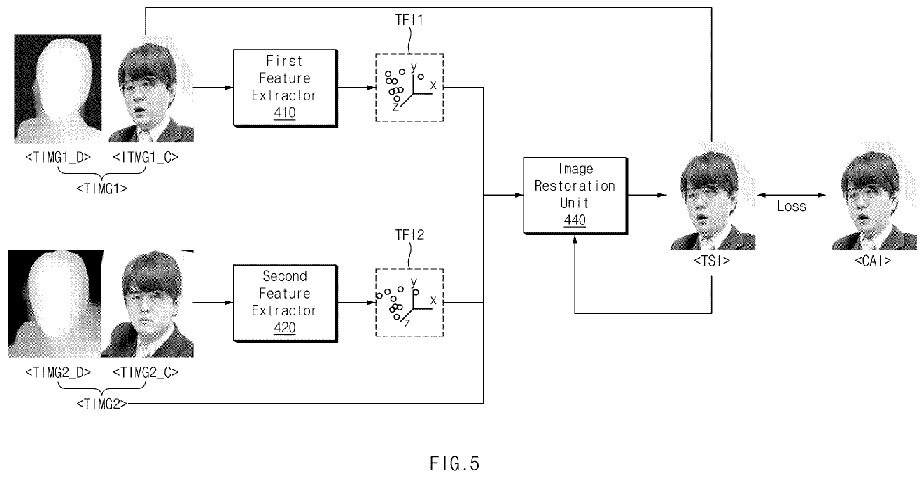

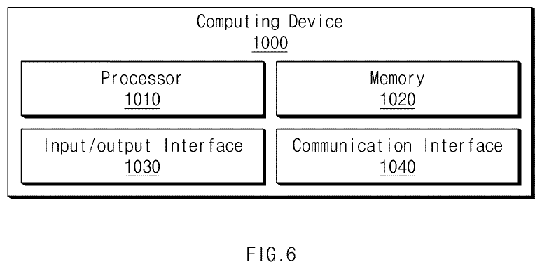

FIG. 6 is a block diagram showing a computing device 1000 corresponding to the image signal processor of FIG. 1.

Referring to FIG. 6, the computing device 1000 may represent an embodiment of a hardware configuration for performing the operation of the image provision device 10 of FIG. 1.

The computing device 1000 may be mounted on a chip that is independent from the chip on which an image sensing device (or image generation device) is mounted. According to one embodiment, the chip on which the image sensing device is mounted and the chip on which the computing device 1000 is mounted may be implemented in one package, for example, a multi-chip package (MCP), but the scope of the present disclosure is not limited thereto.

The computing device 1000 may include a processor 1010, a memory 1020, an input/output interface 1030, and a communication interface 1040.

The processor 1010 may process data and/or instructions required to perform the operations of the components 100 to 500 of the image provision device 10 described in FIG. 1. That is, the processor 1010 may refer to the image signal processor 100, but the scope of the present disclosure is not limited thereto.

The memory 1020 may store data and/or instructions required to perform operations of the components 100 to 500 of the image provision device 10, and may be accessed by the processor 1010. For example, the memory 1020 may be a volatile memory (e.g., Dynamic Random Access Memory (DRAM), Static Random Access Memory (SRAM), etc.) or a non-volatile memory (e.g., Programmable Read Only Memory (PROM), Erasable PROM (EPROM), etc.), EEPROM (Electrically Erasable PROM), flash memory, etc.).

That is, the computer program for performing the operations of the image provision device 10 disclosed in this specification is recorded in the memory 1020 and executed and processed by the processor 1010, thereby implementing the operations of the image signal processor 100.

The input/output interface 1030 is an interface that connects an external input device (e.g., keyboard, mouse, touch panel, etc.) and/or an external output device (e.g., display) to the processor 1010 to allow data to be transmitted and received.

The communication interface 1040 is a component that can transmit and receive various data with an external device (e.g., an application processor, an external memory, etc.), and may be a device that supports wired or wireless communication.

As is apparent from the above description, the image provision device and the image provision method according to embodiments of the present disclosure can provide 3D images using only one image and one video (moving image) without preparing multiple images or multiple videos (moving images).

The embodiments of the present disclosure may provide a variety of effects capable of being directly or indirectly recognized.

Although a number of illustrative embodiments have been described, it should be understood that modifications and enhancements to the disclosed embodiments and other embodiments can be devised based on what is described and/or illustrated in the present disclosure. Furthermore, the embodiments may be combined to form additional embodiments.

What is claimed is:

1. An image provision device comprising:
a first pre-processor configured to generate a first image by detecting a first face region from each frame of an original video;
a second pre-processor configured to generate a second image by detecting a second face region from an original image; and
a similar image generator configured to generate similar images respectively corresponding to a viewer's gaze positions based on the first image and the second image.

2. The image provision device according to claim 1, wherein the similar image generator includes:
a first feature extractor configured to generate first feature information representing features of a face included in the first image;
a second feature extractor configured to generate second feature information representing features of a face included in the second image;
a head rotation component configured to generate correction feature information by converting the first feature information in response to head angle information including head angles respectively corresponding to the gaze positions of the viewer; and
an image restoration component configured to generate the similar images based on the correction feature information, the second feature information, and the second image.

3. The image provision device according to claim 2, wherein each of the first feature information and the second feature information includes:
landmark information including three-dimensional coordinates for each landmark of the face; and
rotation information including rotation angles obtained when the face is rotated about each of a first axis, a second axis, and a third axis perpendicular to each other.

4. The image provision device according to claim 3, wherein the head rotation component is configured to calculate the three-dimensional coordinates of the first feature information changed according to rotation allowing the rotation angle of the first feature information to be equal to the head angle.

5. The image provision device according to claim 3, wherein the landmark includes at least one of a nose, mouth, eyes, ears, and a chin.

6. The image provision device according to claim 3, wherein the rotation angle includes a pitch angle, a yaw angle, and a roll angle.

7. The image provision device according to claim 2, wherein each of the similar images is an image in which the face of the second image has a facial expression included in the first image and the head angle.

8. The image provision device according to claim 2, wherein each of the first feature extractor and the second feature extractor includes a U-net encoder or a self-attention Generative Adversarial Networks (GAN) encoder.

9. The image provision device according to claim 2, wherein the image restoration component is a U-net decoder or a self-attention GAN decoder.

10. The image provision device according to claim 2, wherein the image restoration component is configured to generate the similar images by referring to previously created similar images.

11. The image provision device according to claim 1, further comprising an image display configured to:
select a similar image corresponding to a current gaze position of the viewer, from among the similar images; and
output the selected similar image on a screen.

12. The image provision device according to claim 11, wherein the image display is configured to:
obtain a synthetic image by replacing a face included in the first face region of the original video with a face included in the selected similar image; and
output the synthetic image on the screen.

13. The image provision device according to claim 1, wherein the first pre-processor is configured to generate the first image by cropping the first face region from each frame of the original video.

14. The image provision device according to claim 1, wherein the second pre-processor is configured to generate the second image by cropping the second face region from the original image.

15. The image provision device according to claim 1, wherein the first pre-processor is configured to generate the first image by adjusting the first face region to a predetermined reference size.

16. The image provision device according to claim 15, wherein the second pre-processor is configured to:
adjust a position of the face included in the second face region to a predetermined reference position; and
adjust the adjusted second face region to the reference size to generate the second image.

17. An image provision device comprising:
a similar image generator configured to generate similar images respectively corresponding to a viewer's gaze positions based on a first image generated using each frame of an original video and a second image generated using an original image; and
an image display configured to select a similar image corresponding to a current gaze position of the viewer, from among the similar images, and output the selected similar image on a screen.

18. The image provision device according to claim 17, wherein the similar image generator includes:
a first feature extractor configured to generate first feature information representing features of a face included in the first image;
a second feature extractor configured to generate second feature information representing features of a face included in the second image;
a head rotation component configured to generate correction feature information by converting the first feature information in response to head angle information including head angles respectively corresponding to the gaze positions of the viewer; and
an image restoration component configured to generate the similar images based on the correction feature information, the second feature information, and the second image.

19. The image provision device according to claim 18, wherein each of the first feature information and the second feature information includes:
landmark information including three-dimensional coordinates for each landmark of the face; and
rotation information including rotation angles obtained when the face is rotated about each of a first axis, a second axis, and a third axis perpendicular to each other.

20. The image provision device according to claim 19, wherein the head rotation component is configured to:
calculate the three-dimensional coordinates of the first feature information changed according to rotation allowing the rotation angle of the first feature information to be equal to the head angle.

21. The image provision device according to claim 18, wherein:
each of the similar images is an image in which the face of the second image has a facial expression included in the first image and the head angle.

22. An image provision method comprising:
generating a first image using each frame of an original video;
generating a second image using an original image;
generating similar images respectively corresponding to a viewer's gaze positions based on the first image and the second image; and
selecting a similar image corresponding to a current gaze position of the viewer, from among the generated similar images to output the selected similar image on a screen.

23. The image provision method according to claim 22, wherein the generating the first image includes extracting a next frame when a face region is not detected in any one frame.

24. The image provision method according to claim 22, wherein the generating the second image includes receiving another original image when a face region is not detected in the original image.
